(19) United States
(12) Patent Application Publication
(10) Pub. No.: US 2025/0183552 A1
(43) Pub. Date: Jun. 5, 2025

(54) SELECTIVELY PLATED, FREQUENCY-SCALED ULTRA-WIDEBAND PHASED ARRAY ANTENNA

(71) Applicant: The MITRE Corporation, McLean, VA (US)

(72) Inventors: John Patrick LISTON, Wilmington, MA (US); Mohamed Wajih ELSALLAL, Acton, MA (US); Francisco Fernando RAMOS-CARRIZOSA, Roseville, MN (US); Kevin HANSEN, Cambridge, MA (US)

(73) Assignee: The MITRE Corporation, McLean, VA (US)

(21) Appl. No.: 18/967,146

(22) Filed: Dec. 3, 2024

Related U.S. Application Data
(60) Provisional application No. 63/605,907, filed on Dec. 4, 2023.

(51) Int. Cl. H01Q 21/00; H01Q 1/48

(52) U.S. Cl. CPC H01Q 21/0025; H01Q 1/48; H01Q 21/0087

(57) ABSTRACT

Described herein, according to various aspects, are ultra-wideband, phased array antennas that include non-conductive components that are selectively plated in a conductive material. An exemplary antenna can include a plurality of signal ears and ground ears that are formed along with a base plate from which they extend in an additive manufactured process, thereby reducing the cost and time of manufacturing relative to conventional manufacturing processes. The signal ears and ground ears can be made out of a non-conductive material and selectively plated in a conductive material, thereby allowing for the electrical isolation of certain components, which can increase the operational bandwidth relative to conventional antennas made out of or fully plated in a conductive material.

### CROSS REFERENCE TO RELATED APPLICATIONS

This application claims the benefit of U.S. Provisional Application No. 63/605,907, filed Dec. 4, 2023, the entire contents of which is hereby incorporated by reference.

### FIELD

The present invention relates generally to antennas, and more specifically to ultra-wideband, phased array antennas.

### BACKGROUND

There are increasing demands to develop wideband phased array antennas that include a wide variety of configurations for various applications, such as satellite communications (SATCOM), radar, remote sensing, direction finding, and other systems. The goal is to provide more flexibility and functionality at reduced cost with consideration to limited space, weight, and power consumption (SWaP) on modern military and commercial platforms.

A phased array antenna is an array of antenna elements in which the phases of respective signals feeding the antenna elements are set in such a way that the effective radiation pattern of the array is reinforced in a desired direction and suppressed in undesired directions, thus forming a beam. The relative amplitudes of constructive and destructive interference effects among the signals radiated by the individual elements determine the effective radiation pattern of the phased array. The number of antenna elements in a phased array antenna is often dependent on the required gain of a particular application and can range from isotropic to highly directive levels.

Phased array antennas for ultra-wide bandwidth (more than one octave bandwidth) performance are often large, causing excessive size, weight, and cost for applications requiring many elements. The excessive size of an array may be required to accommodate “electrically large” radiating elements (several wavelengths in length), increasing the total depth of the array. Arrays may also be large due to the nesting of several multi-band elements to enable instantaneous ultra-wide bandwidth performance, which increases the total length and width of the array.

Because conventional arrays are often large and include many individual components, the process for manufacturing an array can be expensive and require a great deal of time and labor. For example, it can be expensive and time consuming to separately manufacture all of the components needed for a conventional array and expensive and time consuming to assemble them together.

### SUMMARY

According to an aspect, an ultra-wideband, phased array antenna can be formed of a non-conductive material that is selectively plated in conductive material. The array can include a plurality of signal ears and ground ears additively formed on a base plate, thereby allowing for the use of additive manufacturing techniques which can substantially reduce the cost and time of manufacturing relative to conventional phased array antenna manufacturing processes. The signal and ground ears of the array can be selectively plated, thereby allowing for conductive characteristics desired for each component without requiring the components to be formed entirely from a conductive material.

A signal ear can include at least one post that connects the signal ear to a base plate of the antenna. This post can enable the signal ear to be formed in the same additive manufacturing process as the base plate. The signal ear can be selectively plated with a conductive material except for the post that connects the base plate so that the signal ear is electrically isolated from the base plate. The signal ear can include a plated post that extends into an opening in the base plate for connection to a feed line. A ground ear can also include a plated first post and a non-plated second post, both of which connect the ground ear to the base plate. This configuration can match the configuration of the signal ear, which can increase bandwidth of the antenna.

According to various embodiments, an antenna element includes: a base plate; a ground member projecting from the base plate, wherein at least a portion of the ground member is plated in a plating material; and a signal member projecting from the base plate adjacent to the ground member, the signal member comprising a first post disposed at least partially within an opening of the base plate and a second post that connects the signal member to the base plate, wherein at least a portion of the signal member is plated in the plating material and the second post is not plated. The first post of the signal member can be plated in the plating material and can be connected to a conductor within the opening of the base plate.

In any of these embodiments, the ground member can include a first post and a second post that connect the ground member to the base plate. The ground member and the signal member can be positioned such that the first post of the ground member and the first post of the signal member are proximate to each other. In some embodiments, the first post of the ground member can be plated in the plating material, and the second post of the ground member can be not plated.

In any of these embodiments, the signal member can be a first signal member. The antenna element can further include a second signal member projecting from the base plate adjacent to the first signal member, the second signal member comprising a first post and a second post. The antenna element can further include a second ground member projecting from the base plate adjacent to the first post of the second signal member. In some examples, the second post of the first signal member and the second post of the second signal member can be integrally manufactured together.

In any of these embodiments, at least a portion of the base plate can be plated in the plating material. The plating material can comprise copper. In some embodiments, the base plate can be electrically grounded. The signal member can be electrically isolated from the base plate and the ground member.

In any of these embodiments, the base plate, the ground member, and the signal member can be formed using an additive manufacturing process. The additive manufacturing process can include one or more of stereolithography, vat polymerization, and 3D printing. In some embodiments, the base plate, the ground member, and the signal member can each comprise at least one plastic.

According to various embodiments, a phased array antenna includes a plurality of unit cells, and each unit cell includes: a base plate; a ground member projecting from the base plate, wherein at least a portion of the ground member is plated in a plating material; and a signal member projecting from the base plate adjacent to the ground member, the signal member comprising a first post disposed at least partially within an opening of the base plate and a second post that connects the signal member to the base plate. At least a portion of the signal member is plated in the plating material and the second post is not plated.

### BRIEF DESCRIPTION OF THE DRAWINGS

The invention will now be described, by way of example only, with reference to the accompanying drawings, in which:

FIG. 1A illustrates a plan view of a selectively plated, dual-polarized phased array antenna according to examples of the disclosure.

FIG. 1B illustrates a closeup view of a unit cell of a selectively plated, dual-polarized phased array antenna according to examples of the disclosure.

FIG. 2 illustrates an isometric view of an antenna element of a selectively plated phased array antenna with a two-post signal ear and ground ear configuration, according to certain embodiments.

FIG. 3 illustrates a side view of an antenna element of a selectively plated phased array antenna with a two-post signal ear and ground ear configuration, according to certain embodiments.

FIG. 4 illustrates an isometric view of an antenna element of a selectively plated phased array antenna with a conjoined-post signal ear configuration, according to certain embodiments.

### DETAILED DESCRIPTION

Described herein, according to various embodiments, are ultra-wideband, phased array antennas that include non-conductive components that are selectively plated in a conductive material. An exemplary antenna can include a plurality of radiating ears that are formed along with a base plate from which they extend in an additive manufactured process, thereby reducing the cost and time of manufacturing relative to conventional manufacturing processes. The radiating ears can be made out of a non-conductive material and can be selectively plated in a conductive material, thereby allowing for the electrical isolation of certain components, which can enable the antenna to be made in an additive manufacturing process that can be faster and lower cost than conventional phased array antenna manufacturing processes.

A phased array antenna, according to certain embodiments, can include a repeating pattern of “unit cells.” Each unit call can include a plurality of radiating elements, each including a pair of radiating ears projecting from the base plate. Each ear may include a comb portion that capacitively couples with a comb portion of an adjacent ear. Each ear may include a post that extends from the comb portion to the base plate, near the post of the adjacent ear. The adjacent comb portions and adjacent posts can be plated. The radiating elements may each include a second post that anchors the element to the base plate. These posts may not be plated. For example, the anchoring post of a signal ear may not be plated so that the signal ear is electrically isolated from the base plate. A ground ear that is electrically connected to the base plate may have a post corresponding to the anchoring post of the ground that is also not plated in order to more closely match the configuration of the signal ear, which can improve the radiative characteristics of the unit cell.

According to some embodiments, the radiating elements can be formed out of a non-conductive material (i.e., a plastic) using an additive manufacturing process. This can reduce the cost and time of manufacturing relative to a conventional manufacturing processes for phased array antennas (e.g., machining of metal). The non-conductive material may then be selectively plated with a conductive material to make the ears conductive. As used herein, “selectively plated,” “selective plating,” and variations thereof refer to non-uniformly plating the phased array antenna. This includes, for example, plating a first portion of a component with a conductive material but not plating a second portion of the component, instead leaving its non-conductive material exposed. Depending on how and where the plating is applied, selectively plating the radiative elements (i.e., the ears) can provide greater control over the electrical isolation of the radiative elements relative to a configuration without selective plating.

One ear of the pair of ears can be a signal or active component of the radiating element (referred to herein a signal ear) and can be connected to the feed conductor of a feed line. The signal ear includes a plated first post, which extends into an opening in the base plate and connects to the feed connector on the other side of the base plate, and a non-plated second post, which connects the signal ear to the base plate and serves as the mechanical support for the signal ear. The signal ear can be selectively plated by plating, for example, the first post (extending into the opening) and not plating the second post (connected to the base plate), thus electrically isolating the signal ear from the base plate and thereby improving the operational bandwidth of the antenna.

The other ear of the pair of ears can be a ground component of the radiating element (referred to herein as the “ground ear”). The ground ear can be terminated either to the ground of a connector used for connecting a feed line or directly to the base plate, which is electrically grounded. The ground ear can include two posts: a plated first post and a non-plated second post, both of which may connect the ground ear to the base plate. The shape and selective plating of the ground ear can intentionally mirror that of the signal ear to improve the radiative characteristics of the antenna, thereby improving bandwidth.

In the following description of the disclosure and embodiments, reference is made to the accompanying drawings in which are shown, by way of illustration, specific embodiments that can be practiced. It is to be understood that other embodiments and examples can be practiced and changes can be made without departing from the scope of the disclosure.

In addition, it is also to be understood that the singular forms “a,” “an,” and “the” used in the above description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

Reference is sometimes made herein to an array antenna having a particular configuration (e.g., a planar array). One of ordinary skill in the art would appreciate that the techniques described herein are applicable to various sizes and shapes of array antennas. It should thus be noted that although the description provided herein describes the concepts in the context of a rectangular array antenna, those of ordinary skill in the art would appreciate that the concepts equally apply to other sizes and shapes of array antennas including, but not limited to, arbitrarily shaped planar array antennas as well as cylindrical, conical, spherical and arbitrarily shaped conformal array antennas.

Reference is also made herein to the array antenna including radiating elements of a particular size and shape. For example, certain embodiments of radiating element are described having a shape and a size compatible with operation over a particular frequency range (e.g., 1.8-18 GHz). Those of ordinary skill in the art would recognize that other shapes of antenna elements may also be used and that the size of one or more radiating elements may be selected for operation over any frequency range in the RF frequency range (e.g., any frequency in the range from below 20 MHz to above 50 GHz).

Reference is sometimes made herein to generation of an antenna beam having a particular shape or beam width. Those of ordinary skill in the art would appreciate that antenna beams having other shapes and widths may also be used and may be provided using known techniques such as by inclusion of amplitude and phase adjustment circuits into appropriate locations in an antenna feed circuit.

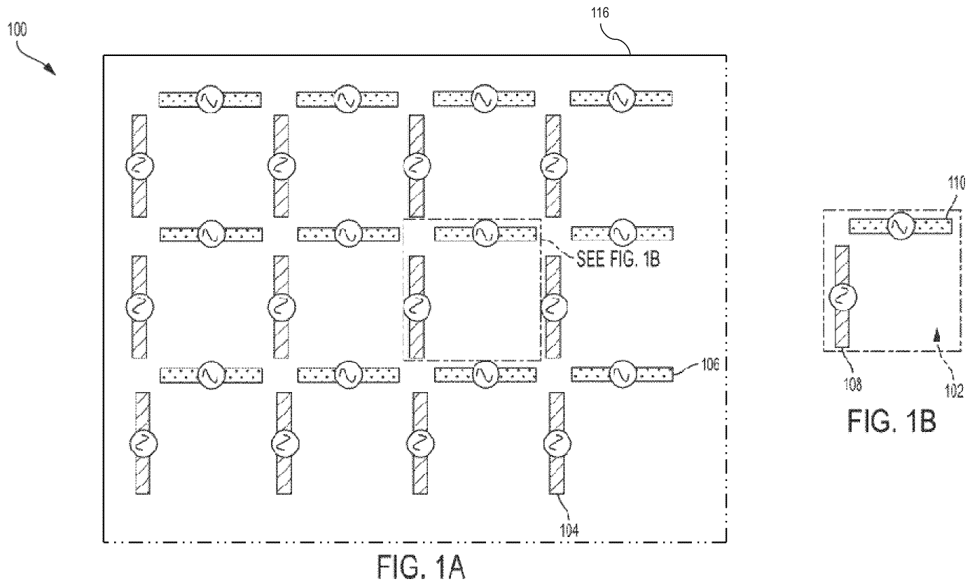

FIG. 1A illustrates an exemplary array 150 of radiating elements (e.g., vertical radiating elements 104 and horizontal radiating elements 106) that can form an ultra-wideband, phased array antenna 100, according to certain embodiments. In this embodiment, a dual polarized configuration is shown with radiating elements oriented both horizontally 106 and vertically 104 on a base plate 116. The base plate 116 is positioned beneath and supports the radiating elements of the array 150. As illustrated in a closeup view of this embodiment (FIG. 1B), a unit cell 102 includes a single horizontally polarized radiating element 110 and a single vertically polarized radiating element 108. Array 150 is a 4×3 array of unit cells 102. According to certain embodiments, array 150 can be scaled up or down to operate over a specified frequency range. More unit cells 102 can be added to meet other specific design requirements such as antenna gain. According to certain embodiments, modular arrays of a predefined size may be combined into a desired configuration to create an array to meet the required performance of a particular antenna. For example, a module may include the 4×3 array 150 of unit cells 102 illustrated in FIG. 1A, and a particular antenna application 100 requiring 96 radiating elements can be built using eight modules fitted together (thus, providing the 96 radiating elements). This modular design allows for arrays to be tailored to specific antenna design requirements at a lower cost. As used herein, “unit cell” refers to a logical subdivision of a phased array antenna and is not intended to be limited to a distinct component or subassembly, although a unit cell component or subassembly is included within the scope of the disclosure.

As shown in FIG. 1B, radiating element 108 is disposed along a first axis and radiating element 110 is disposed along a second axis that is orthogonal to the first axis, such that radiating element 108 is substantially orthogonal to radiating element 110. This orthogonal orientation results in each unit cell 102 being able to generate orthogonally directed electric field polarizations. That is, by disposing one set of radiating elements (e.g., vertical radiating elements 104) in one polarization direction and disposing a second set of radiating elements (e.g., horizontal radiating elements 106) in the orthogonal polarization direction, an antenna which can generate signals having any polarization is provided. In this particular example, unit cells 102 are disposed in a regular pattern, which here corresponds to a square grid pattern. Those of ordinary skill in the art would appreciate that unit cells 102 need not all be disposed in a regular pattern. In some applications, it may be desirable or necessary to dispose unit cells 102 in such a way that radiating elements 108 and 110 of each unit cell 102 are not aligned between every unit cell 102. Thus, although shown as a square lattice of unit cells 102, it would be appreciated by those of ordinary skill in the art, that antenna 100 could include but is not limited to a rectangular or triangular lattice of unit cells 102 and that each of the unit cells can be rotated at different angles with respect to the lattice pattern.

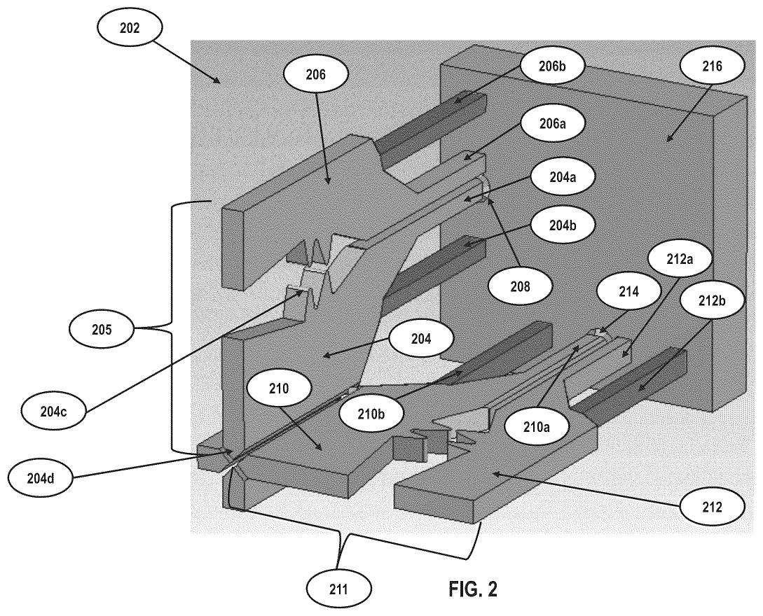

Each of radiating elements 108 and 110 include a pair of ears projecting from the base plate. Examples of such ears are described in greater detail in the description for FIG. 2 below. Each ear includes a comb portion that capacitively couples with the comb portions of adjacent ears to combine the electromagnetic fields of adjacent radiating elements and at least one post that extends from the comb portion toward the base plate, such as for connecting the ear to the base plate. The ears can be formed out of a non-conductive material (i.e., a plastic), which may then be selectively plated with a conductive material to make portions of the ears conductive. As used herein, “plating” refers to coating one or more surfaces of an object (e.g., an ear) made of a first material with a layer of a second material. If the layer of the second material is not applied uniformly to all surfaces of the object, the object is “selectively plated.” Thus, selectively plating ears may involve, for example, plating a first portion (e.g., a first post) of an ear with a conductive material but not plating a second portion (e.g., a second post) of the ear, and instead leaving its non-conductive material exposed.

One ear of the pair of ears can be a signal or active component of the radiating element (referred to herein a signal ear) and can be connected to the feed conductor of a feed line. The signal ear may be configured to capacitively couple with adjacent ears of adjacent radiating elements to combine the electromagnetic fields of the radiating elements. The other ear of the pair of ears can be a ground component of the radiating element (referred to herein as a ground ear). The ground ear can be terminated either to the ground of a connector used for connecting a feed line or directly to the base plate, which is electrically grounded. The shape and selective plating of the ground ear can intentionally mirror that of the signal ear to improve the radiative characteristics of the antenna, thereby improving bandwidth.

FIG. 2 illustrates a unit cell 202 of an exemplary array of radiating elements that are selectively plated, according to certain embodiments. Unit cell 202 includes two radiating elements, a first radiating element 205 and a second radiating element 211, oriented perpendicularly with respect to one another such as for providing right-hand and left-hand circular polarization, as discussed above. Each of the first and second radiating elements 205 and 211 includes a signal ear and a ground ear. First radiating element 205 includes a signal ear 204 and a ground ear 206 oriented along a first polarization axis (referred to herein as “vertically polarized”). Second radiating element 211 includes a signal ear 210 and a ground ear 212 oriented along a second polarization axis (referred to herein as “horizontally polarized”). The perpendicular orientation between first radiating element 205 and second radiating element 211 allows the array to be configured as a dual-polarized array, meaning the array can send and receive signals in orthogonal polarizations. Thus, unit cell 202 can be used in a dual-polarized phased array antenna, for example, for unit cell 102 of antenna 100 of FIG. 1.

As shown in FIG. 2, both signal ear 204 and ground ear 206 project from the base plate 216. It is noted that signal ears may also be referred to herein as signal members, and ground ears may be referred to herein as ground members. The signal ear 204 and ground ear 206 pair are positioned near each other, as well as near other ears projecting from the base plate 216. This allows the signal ear 204 to capacitively couple with adjacent ears of adjacent radiating elements (e.g., signal ear 210 of second radiating element 211) to combine the electromagnetic fields of adjacent radiating elements. The signal ear 204 connects to a feed network that provides the signals for beam forming and steering. The ground ear 206 provides a voltage differential to its paired signal ear 204. A signal beam can be generated by exciting the first radiating element 205, i.e., by generating a voltage differential between signal ear 204 and ground ear 206. The generated signal beam has a direction along the centerline of the first radiating element 205, perpendicular to base plate 216. Second radiating element 211 may also have similar properties as those of first radiating element 205 described above.

According to certain embodiments, signal ear 204 is an antenna element that is electrically connected to a feed line and/or a feed network that provides the signals for beam forming and steering. Signal ear 204 may project orthogonally from base plate 216 such that its centerline is perpendicular to the largest surface of base plate 216. Signal ear 204 may be electrically isolated from ground ear 206 and base plate 216. The shape of the signal ear 204 can be configured to optimize the input impedance of the antenna. For example, signal ear 204 may include a comb portion 204c that includes a plurality of irregularly shaped lobes or projections. The comb portion 204c may be located at the distal end (i.e., the end farther away from base plate 216) of the signal ear 204. The placement, sizes, shapes, spacing, and numbers of the lobes can affect the impedance transformation of the first radiating element 205. The signal ear 204 may also include a capacitive coupling portion 204d which forms a capacitive interface with a capacitive coupling portion of an adjacent signal ear (e.g., signal ear 210 of second radiation element 211).

Signal ear 204 may include a signal post 204a that extends at least partially into an opening 208 of base plate 216. The signal post 204a can be electrically connected to a feed network and provides a signal pathway connecting the signal ear 204 to the feed network. For example, the signal post 204a can be connected to the center of a coaxial feed line by a suitable connector. The signal ear 204 includes a support post 204b that mechanically supports the signal ear 204 and connects the signal ear 204 to base plate 216, enabling the signal ear to be additively manufactured with the base plate 216. Because the signal ear 204 is made of a non-conductive (e.g., plastic) material, some portions of the signal ear 204 may be plated (i.e., covered in a layer of a conductive material) in order to conduct electricity through those portions, and other portions of the signal ear 204 may be left plated in order to electrically isolate those portions. As shown in FIG. 2, the signal post 204a may be plated in the conductive material, thereby allowing it to perform its electrical function. Conversely, the support post 204b may be left plated such that the signal ear 204 is electrically isolated from the base plate 216, thereby preventing the signal ear 204 from being grounded.

One or more portions of the signal ear 204 (i.e., signal post 204a, support post 204b, comb portion 204c, and capacitive coupling portion 204d) can be formed out of one or more non-conductive materials (i.e., a plastic) using an additive manufacturing process. This reduces the cost and time of manufacturing relative to manufacturing processes for one or more conductive materials (i.e., a metal). One or more portions of the non-conductive material may then be selectively plated with a conductive material to make those portions of the signal ear 204 conductive, thereby allowing it to perform its radiative and/or electrical function. In some embodiments, plating the capacitive coupling portion 204d allows for very tight spacing between capacitive coupling portions of adjacent signal ears, which may not be achievable with conventional machined and assembled arrays. In some embodiments, signal post 204a, support post 204b, comb portion 204c, and capacitive coupling portion 204d may all be formed out of a non-conductive plastic, and all of those portions except support post 204b may be plated in the conductive metal. Plating only the signal post 204a (extending into the opening) and not plating the support post 204b (connected to the base plate 216) electrically isolates the signal ear 204 and may thereby improve the operational bandwidth of the antenna.

Plated signal post 204a can extend into opening 208 within base plate 216. The opening 208 can be shaped in the additive manufacturing process. With the plated signal post 204a not being connected to the base plate 216, the non-plated support post 204b can provides the support to the signal ear 204 that enables it to be additively manufactured with the base plate 216 and ensures that it remains attached to the phased array during operation.

According to certain embodiments, the ground ear 206 is an antenna element that is electrically connected to the ground of the antenna. The ground ear 206 can be terminated either to the ground of a connector used for connecting a feed line or directly to the base plate, which is electrically grounded. As shown in FIG. 2, the ground ear 206 can mirror the shape of the signal ear 204 and include two support posts-plated post 206a and non-plated post 206b. Both plated post 206a and non-plated post 206b can be directly integrated into base plate 216, thereby providing a direct path to ground for the ground ear 206. Although it is not necessary for the ground ear 206 to have one plated post and one non-plated post (e.g., both posts could be plated), having such a configuration allows the ground ear 206 to be symmetric in configuration (i.e., shape and selective plating) to the signal ear 204. Having signal and ground components of the same configuration improves the radiative characteristics of the antenna, thereby improving bandwidth. Signal ear 210 and ground ear 212 may also have similar properties as those of signal ear 204 and ground ear 206 described above.

According to certain embodiments, signal ear 204 and ground ear 206 may be positioned such that the plated posts 204a and 206a of signal ear 204 and ground ear 206, respectively, are proximate to each other. The plated posts 204a and 206a may be parallel to each other and spaced apart by a certain (e.g., small) distance or spacing. According to certain embodiments, the distance between the plated posts 204a and 206a is less than 0.5 inches, less than 0.1 inches, or less than 0.05 inches. According to certain embodiments, the spacing is less than 0.025 inches, less than 0.02 inches, less than 0.015 inches, or less than 0.010 inches. According to some embodiments, the spacing between the plated posts 204a and 206a is selected to optimize the impedance matching of the first radiating element 205. According to some embodiments, the spacing is selected based on the configuration of a feed connector on the opposite side of base plate 216 to the first radiating element 205. According to some embodiments, the distance between the plated posts 204a and 206a may be scaled with frequency (for example, the distance may be a function of the wavelength of the highest designed frequency). For example, according to some embodiments, the distance can be less than 0.05λ, less than 0.025λ, or less than 0.013λ. According to some embodiments, the distance can be greater than 0.001λ, greater than 0.005λ, greater than 0.01λ, or greater than 0.05λ. Signal ear 210 and ground ear 212 may also be positioned in the manner of signal ear 204 and ground ear 206 described above.

As discussed previously, signal ear 204 and ground ear 206 are connected to and arranged along a surface of base plate 216. According to certain embodiments, base plate 216 may include a solid block of material with openings, cutouts, or airgaps, such as opening 208, to accommodate the signal post 204a of signal ear 204, as well as a connector (e.g., one or more of an elastomeric connector such as a Fujipoly Zebra® connector, a RF interposer such as a Fuzz Button® connector, and a SMA connector) for connecting a feed line to the signal ear 204. It is noted that openings may also be described as airgaps, holes, slots, or cutouts of any shape.

During additive manufacturing of the base plate and radiating ears, the opening 208 is an air gap between the base plate and the post of the signal ear. The size of the opening 208 can be large enough to ensure that the plated post 204a does not inadvertently make contact with the base plate 216 during operation of the phased array antenna. If the diameters of opening 208 is too small, then during operation of the phased array antenna, signal ear 204 may vibrate and make intermittent contact with the base plate 216, intermittently grounding the signal ear 204 and thereby degrading the performance of the antenna. The size of the opening 208 can be further constrained by the ground ears 206, and more specifically by its plated post 206a, which is positioned proximate to the plated post 204a disposed partially within the opening 208. If the diameter of the opening 208 is too large, then the opening 208 may overlap with the area on the base plate 216 that is supposed to be integrated with plated post 206a, thereby degrading the connection between the ground ear 206 and the base plate 216. According to certain embodiments, after plating of the plated post 204a, the opening 208 can be filled with a material other than air, such as a resin or other non-conductive material injected into the opening 208, which can provide additional stability and structural support to the plated post 204a. Optionally, the opening 208 can be plated.

According to certain embodiments, the choice of diameter of the opening 208 can also be influenced by the desired impedance of the signal ear 204. In order to achieve suitable impedance matching between the base plate 216 and signal ear 204, the diameter of the corresponding opening 208 can be controlled to ensure that an impedance mismatch does not occur. As the impedance of the signal ears 204 is proportional to the diameters of its plated post 204a the ratio of the diameter of the plated post 204a to the diameter of the corresponding opening 208 can be controlled so as to achieve suitable impedance matching. Opening 214 may also have similar properties as those of opening 208 described above.

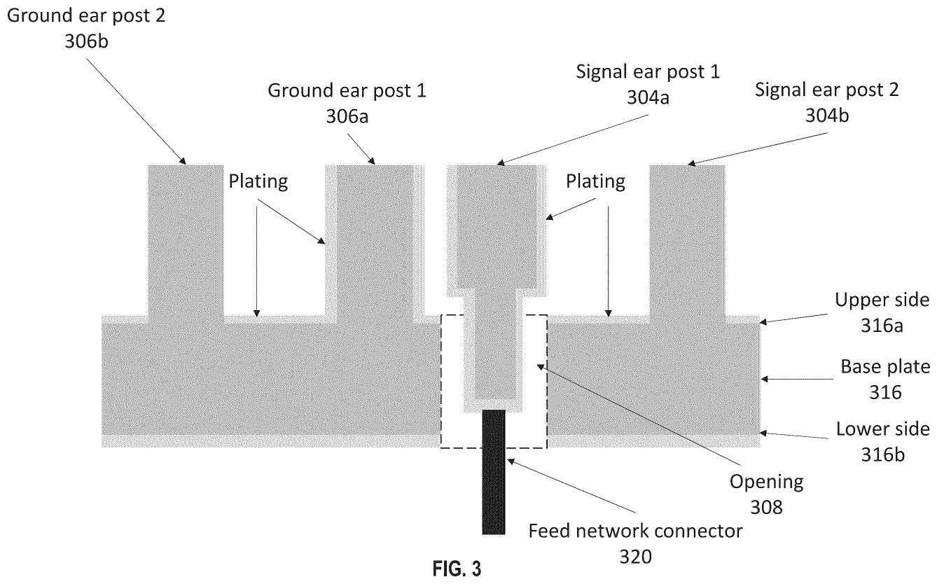

FIG. 3 illustrates a close-up view of an example of how various components may be plated. As shown in FIG. 3, a first signal ear post 304a may be disposed at least partially within an opening 308 of the base plate 316. Opening 308 is configured such that the first signal ear post 304a does not make contact with the base plate 316. Optionally, the first signal ear post 304a may be connected to a feed network connector 320 and/or a feed line. This feed network connector 320 may be disposed within the hole of the base plate 316, positioned on the other side of the base plate 316 relative to the posts, or both.

Since the first signal ear post 304a does not connect to the base plate 316 and thus may not provide structural support for the signal ear, a second signal ear post 304b may be used to support the signal ear 304a atop the base plate 316 and makes it possible to additively manufacture the signal ear along with the base plate 316. The first signal ear post 304a may be positioned proximate to a first ground ear post 306a on a side opposite the position of the second signal ear post 304b. Unlike the first signal ear post 304a, the first ground ear post 306a may be connected to the base plate 316 with no opening. To mirror the configuration of the signal ear, a second ground ear post 306b may be positioned proximate to the first ground ear post 306a.

As shown in the example of FIG. 3, first signal ear post 304a and first ground ear post 306a may be plated in a conductive plating material. Second signal ear post 304b and second ground ear post 306b may be left non-plated. However, in this embodiment, the selective plating of the ground ear and the signal ear intentionally mirror each other because having signal and ground components of the same form factor may improve the radiative characteristics of the antenna, thereby improving bandwidth. The base plate 316 may be plated on the upper side 316a and, optionally, on the lower side 316b. The opening 308 is shown non-plated but may be plated.

The components illustrated in FIG. 3 may have similar properties as their corresponding components from other embodiments. For example, the signal ear posts 304a and 304b can have similar properties as those of posts 204a, 204b, 210a, and 210b of FIG. 2; the ground ear posts 306a and 306b can have similar properties as those of posts 206a, 206b, 212a, and 212b of FIG. 2; opening 308 can have similar properties as those of openings 208 or 214 of FIG. 2; and base plate 316 can have similar properties as those of base plate 216 of FIG. 2.

Referring back to FIG. 2, the first radiating element 205 may be positioned proximate to other radiating elements of the array. For example, as shown in FIG. 2, first radiating element 205 and second radiating element 211 may be proximately positioned and perpendicularly oriented with respect to one another. The second radiating element 211 may include components similar to those of the first radiating element 205 (e.g., signal ear 210 having a plated post 210a and a non-plated post 210b, and ground ear 212 having a plated post 212a and a non-plated post 212b). The orientation of the second radiating element 211 may mirror that of the first radiating element 205, only transformed by rotation. For example, as shown in FIG. 2, the second radiating element 211 may be rotated 90 degrees from the orientation of the first radiating element 205 such that, if the first radiating element 205 is vertically oriented, the second radiating element 211 is horizontally oriented. In some embodiments, a radiating element may be positioned proximate to two, three, four, five, or more other radiating elements of the array. One or more adjacent radiating elements may be capacitively coupled to each other.

To perform this capacitive coupling, the capacitive coupling portions of the signal ears of adjacent radiating elements may be positioned proximate to each other. For example, as shown in FIG. 2, signal ear 204 of first radiating element 205 and signal ear 210 of second radiating element 211 may be positioned proximate to each other. According to certain embodiments, the capacitive coupling portions of each signal ear can include a triangular-shaped end piece that is shaped to present an optimal amount of surface area to each other, such that signal ears 204 and 210 are capacitively coupled. The triangular-shaped end pieces may be spaced apart by a certain distance or spacing. According to certain embodiments, the distance between the triangular-shaped end pieces is less than 0.5 inches, less than 0.1 inches, or less than 0.05 inches. According to certain embodiments, the spacing is less than 0.025 inches, less than 0.02 inches, less than 0.015 inches, or less than 0.010 inches. According to some embodiments, the spacing between the triangular-shaped end pieces is selected to optimize the capacitive coupling of the signal ears 204 and 210.

As described above, each signal ear and each ground ear can have its own plated post and non-plated post, and the posts of each ear are not attached to the posts of any other ear. Alternatively, in some embodiments, it may be desirable for two or more posts, each post from a different ear, to be conjoined (e.g., integrally manufactured as one piece). As used herein, “integrally manufactured” refers to two or more components being formed during the manufacturing process to make up one single piece. For example, a conjoined-post configuration may provide extra stability for the ears of the array. When the posts of different ears are conjoined, the ears are fixed and stabilized at a certain distance apart from each other. Fixing the distance between ears may also preserve the optimal capacitive coupling distance between signal ears, thereby improving the operational bandwidth of the antenna. However, the conjoined-post configuration may not be appropriate in some embodiments because it requires more material to manufacture, thereby making the antenna heavier and more expensive. Furthermore, the additional material of the conjoined post may affect impedance matching between signal ears and the baseplate, which, depending on the amount and placement of the material required for the conjoined post, may reduce the operational bandwidth of the antenna. To some extent, the negative effects of the conjoined-post configuration on impedance matching can be mitigated by conjoining only the non-plated posts, which are non-conductive and minimally involved in the electrical configuration of the array.

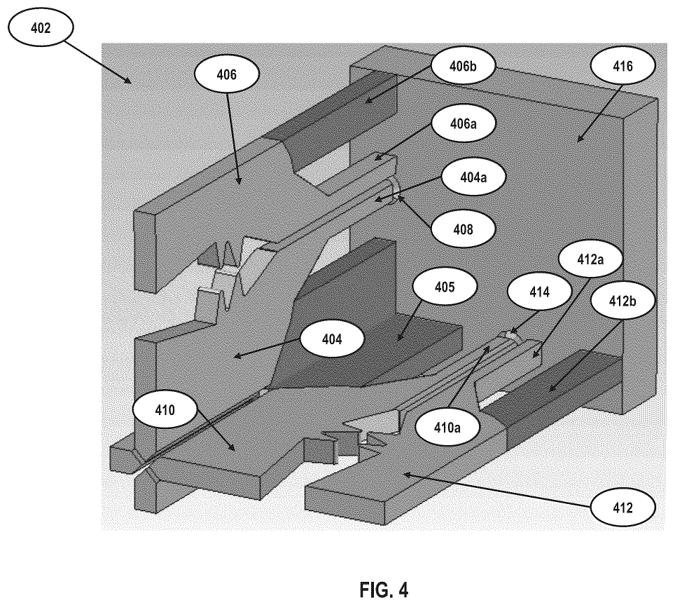

FIG. 4 illustrates a unit cell 402 of an exemplary array of radiating elements that are selective plated and have a conjoined-post configuration, wherein the non-plated posts of adjacent ears are conjoined, according to certain embodiments. It may be advantageous from a printing standpoint to widen the support structure underneath the signal and ground ears. Unit cell 402 includes a vertically polarized radiating element comprising a signal ear 404 (with plated post 404a) disposed partially within an opening 408 and a ground ear 406 (with plated post 406a and non-plated post 406b), a horizontally polarized radiating element comprising a signal ear 410 (with plated post 410a) disposed partially within an opening 414 and a ground ear 412 (with plated post 412a and non-plated post 412b), a base plate 416, and a non-plated conjoined post 405 which projects from the base plate 416 and connects signal ear 404 to signal ear 410. The structure of unit cell 402 is similar to the structure of unit cell 202, with the exception of the non-plated conjoined post 405 in place of the non-plated posts 204b and 210b of unit cell 202. Accordingly, the components of unit cell 402 can share the described features of the components of unit cell 202, and vice versa. For example, ground ears 406 and 412 of FIG. 4 can share the features of ground ears 206 and 212 of FIG. 2, and vice versa.

Non-plated conjoined post 405 can be positioned beneath the signal ears 404 and 410, thereby connecting them to each other and to the base plate 416. The shape of non-plated conjoined post 405 can be any shape capable of being positioned in such a manner. For example, non-plated conjoined post 405 may be a L-shaped extrusion that extends perpendicularly from the base plate 416 to one or more surfaces of signal ears 404 or 410. According to certain embodiments, non-plated conjoined post 405 may resemble non-plated posts 204b and 210b of FIG. 2 if they were integrally manufactured together as one piece. For example, one or more members may connect two or more posts that extend perpendicularly from the base plate 416, and the member-post assembly may be integrally manufactured.

In some embodiments, a radiating element may be integrally manufactured such that each signal ear, each ground ear, and the base plate are manufactured or machined in one piece. The radiating element may be integrally manufactured using an additive manufacturing process. One benefit of integral manufacturing is that, because components that would otherwise be manufactured separately are now manufactured together, no assembly is required to arrange the signal ears and ground ears on the baseplate. However, integral manufacturing also means that individual components may be difficult to remove or replace, which may not be desirable in some embodiments.

In accordance with the foregoing, according to certain embodiments, a vertically polarized radiating element of a phased array antenna is of the same size, shape, and spacing as a horizontally polarized radiating element. However, phased array antennas according to other embodiments, may include only single polarized radiating elements (e.g., only rows of horizontally polarized radiating elements). According to some embodiments, the spacing of one set of radiating elements (e.g., the horizontally polarized elements) is different from the spacing of the other set of radiating elements (e.g., the vertically polarized elements). According to some embodiments, the radiating element spacing within a row may not be uniform. For example, the spacing between first and second elements within a row may be different than the spacing between the second and third elements.

According to some embodiments, the signal ears and the ground ears described herein are solid antenna elements. According to certain embodiments, the thickness of these elements is less than 0.5 inches or less than 0.25 inches. According to certain embodiments, the thickness is preferably less than 0.125 inches, less than 0.063, less than 0.032, less than 0.016, or less than 0.008 inches. According to certain embodiments, the thickness is between 0.035 and 0.045 inches. According to certain embodiments, the thickness is greater than 0.03 inches, greater than 0.1 inches, greater than 0.25 inches, greater than 0.5 inches, or greater than 1 inch. According to some embodiments, the thickness may be scaled with frequency (for example, the distance may be a function of the wavelength of the highest designed frequency). For example, according to some embodiments, the thickness can be less than 0.2λ, less than 0.1λ, less than 0.05λ, or less than 0.01λ. According to some embodiments, the thickness can be greater than 0.005λ, greater than 0.01λ, greater than 0.05λ, or greater than 0.1λ.

According to certain embodiments, the signal ears, ground ears, and base plates described herein are formed from any one or more materials suitable for use in a radiating antenna. In a preferred embodiment, one or more of these materials is a non-conductive material, for example plastics such as Acrylonitrile butadiene styrene (ABS), Nylon, Polyamides (PA), Polybutylene terephthalate (PBT), Polycarbonates (PC), Polyetheretherketone (PEEK), Polyetherketone (PEK), Polyethylene terephthalate (PET), Polyimides, Polyoxymethylene plastic (POM/Acetal), Polyphenylene sulfide (PPS), Polyphenylene oxide (PPO), Polysulphone (PSU), Polytetrafluoroethylene (PTFE/Teflon), or Ultra-high-molecular-weight polyethylene (UHMWPE/UHMW). At least a portion of the surface of a non-conductive material may be coated or plated with a suitable conductive material, such as copper, gold, silver, or nickel. In a preferred embodiment, the signal ears, ground ears, and base plates are formed using an additive manufacturing process, such as stereolithography (SLA), vat polymerization, or 3D printing. Each of the signal ears, ground ears, and base plates may comprise at least one plastic material and/or at least one metal material.

In some embodiments, the signal ears, ground ears, and base plates described herein are formed, in part, from materials that are substantially conductive and that are relatively easy to machine, cast and/or solder or braze. For example, the materials may include copper, aluminum, gold, silver, beryllium copper, or brass. It is noted that the non-plated posts of the signal ears may not be formed from these substantially conductive materials.

In some embodiments, the signal ears, ground ears, and base plates described herein may be substantially or completely solid. In other embodiments, they may be substantially or completely hollow, or have some combination of solid and hollow portions. For example, one or more of the signal ears, ground ears, and base plates may include a number of planar sheet cutouts that are soldered, brazed, welded or otherwise held together to form a hollow three-dimensional structure. According to some embodiments, one or more of the signal ears, ground ears, and base plates are machined, molded, cast, or formed by wire-EDM. According to some embodiments, one or more of the signal ears, ground ears, and base plates are 3D printed, for example, from a conductive material or from a non-conductive material that is then coated or plated with a conductive material.

According to certain embodiments, the base plates described herein are designed to be modular and includes features in the ends that can mate with adjoining modules. Such interfaces can provide both structural rigidity and cross-interface conductivity. Modules may be various sizes incorporating various numbers of unit cells of radiating elements. According to certain embodiments, a module is a single unit cell. According to certain embodiments, modules are several unit cells (e.g., 2×2, 4×4), dozens of unit cells (e.g., 5×5, 6×8), hundreds of unit cells (e.g., 10×10, 20×20), thousands of unit cells (e.g., 50×50, 100×100), tens of thousands of unit cells (e.g., 200×200, 400×400), or more. According to certain embodiments, a module is rectangular rather than square (i.e., more cells along one axis than along the other).

According to certain embodiments, the base plate of the first module may include partial cutouts along its edge to mate with partial cutouts along the edge of the next module to form a receptacle to receive the radiating elements along the edges of the two modules. According to certain embodiments, the base plate of a module extends further past the last set of radiating elements along one edge than it does along the opposite edge in order to incorporate a last set of receptacles used to receive the set of radiating elements that form the transition between one module and the next. In these embodiments, the receptacles along the perimeter of the array remain empty. According to certain embodiments, a transition strip is used to join modules, with the transition strip incorporating a receptacle for the transition radiating elements. According to certain embodiments, no radiating elements bridge the transition from one module to the next. Arrays formed of modules according to certain embodiments can include various numbers of modules, such as two, four, eight, ten, fifteen, twenty, fifty, a hundred, or more.

According to certain embodiments, the base plates described herein can provide structural support for each radiating element and provide overall structural support for the array or module. A base plate may be of various thicknesses depending on the design requirements of a particular application. For example, an array or module of thousands of radiating elements may include a base plate that is thicker than the base plate of an array or module of a few hundred elements in order to provide the required structural rigidity for the larger dimensioned array. According to certain embodiments, the base plate is less than 6 inches thick. According to certain embodiments, the base plate is less than 3 inches thick, less than 1 inch thick, less than 0.5 inches thick, less than 0.25 inches thick, or less than 0.1 inches thick. According to certain embodiments, the base plate is between 0.2 and 0.3 inches thick. According to some embodiments, the thickness of the base plate may be scaled with frequency (for example, as a function of the wavelength of the highest designed frequency, λ). For example, the thickness of the base plate may be less than 1.0λ, 0.5λ, or less than 0.25λ. According to some embodiments, the thickness of the base plate is greater than 0.1λ, greater than 0.25λ, greater than 0.5λ, or greater than 1.0λ.

According to some embodiments, the form factors of radiating elements described herein may be selected to optimize the impedance of the antenna. In addition to the shape, the thickness of a radiating element ear may also affect the impedance transformation of the radiating element. According to certain embodiments, the thickness is less than 0.5 inches or less than 0.25 inches. According to certain embodiments, the thickness is preferably less than 0.125 inches, less than 0.063, less than 0.032, less than 0.016, or less than 0.008 inches. According to certain embodiments, the thickness is between 0.035 and 0.045 inches. According to certain embodiments, the thickness is greater than 0.03 inches, greater than 0.1 inches, greater than 0.25 inches, greater than 0.5 inches, or greater than 1 inch. According to some embodiments, the thickness may be scaled with frequency (for example, the distance may be a function of the wavelength of the highest designed frequency). For example, according to some embodiments, the thickness can be less than 0.2λ, less than 0.1λ, less than 0.05λ, or less than 0.01λ. According to some embodiments, the thickness can be greater than 0.005λ, greater than 0.01λ, greater than 0.05λ, or greater than 0.1λ.

According to certain embodiments, a radiating element ear includes one lobe, two lobes, four lobes, five lobes, or more. According to certain embodiments, instead of lobes, the radiating element ear includes comb-shaped teeth, saw-tooth shaped lobes, blocky lobes, or a regular wave pattern. According to some embodiments, ears of radiating elements have other shapes, for example they may be splines, or straight lines. Straight line designs may be desirable if the antenna array is designed to operate only at a single frequency, if for example, the frequency spectrum is polluted at other frequencies. As appreciated by one of ordinary skill in the art, various techniques can be used to simulate the impedance transformation of radiating elements in order to tailor the shapes of the inner-facing irregular surfaces to the impedance transformation requirements for a given phased array antenna design.

In addition to impedance matching, the shape of the inner-facing surfaces of the comb portions of the radiating element ears described herein can affect the operational frequency range of the antenna. Other design considerations may also affect the frequency range. For example, the shape of the capacitive coupling portions described herein and the manner in which they interface with adjoining capacitive coupling portions can affect the frequency range. According to certain embodiments, a radiating element can be designed with certain dimensions to operate in a radio frequency band from 1.8 to 18 GHz. For example, a radiating element may be between 0.5 inches and 0.3 inches tall (preferably between 0.45 inches and 0.35 inches tall) from the top of base plate to the top of the radiating element. According to some embodiments, the height of the radiating elements may be scaled with frequency (for example, the height may be a function of the wavelength of the highest designed frequency). For example, according to some embodiments, the height can be less than 2.0λ, less than 1.0λ, less than 0.75λ, less than 0.5λ, or less than 0.25λ. According to some embodiments, the height can be greater than 0.1λ, greater than 0.2λ, greater than 0.5λ, or greater than 1.0.

The posts of the radiating elements described herein may be between than 0.5 inches and 0.1 inches tall and preferably between 0.2 inches and 0.25 inches tall. The posts may be scaled by the radiating element's height. For example, the height of the posts may be equal to or less than ¾ of the element height, equal to or less than ⅔ the element height, equal to or less than 12 the element height, or equal to or less than of the element height. According to some embodiments, comb portions and/or capacitive coupling portions constitute the remainder of the element height. According to some embodiments, comb portions and/or capacitive coupling portions may be between 0.1 and 0.3 inches tall and preferably between 0.15 and 0.2 inches tall. According to certain embodiments, the distance from the outer edge of the capacitive coupling portion of a first ear to the outer edge of the capacitive coupling portion of a second ear may be between 0.15 inches and 0.30 inches and preferably between 0.2 and 0.25 inches. According to certain embodiments, these values are scaled up or down for a desired frequency bandwidth. For example, arrays designed for lower frequencies are scaled up (larger dimensions) and arrays designed for higher frequencies are scaled down (smaller dimensions).

Phased array antennas, according to certain embodiments, may reduce the number of antennas which need to be implemented a given application by providing a single antenna that serves multiple systems. In reducing the number of required antennas, embodiments of the present invention may provide a smaller size, lighter weight alternative to conventional, multiple-antenna systems resulting in lower cost, less overall weight, and reduce aperture.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. An antenna element comprising:
a base plate;
a ground member projecting from the base plate, wherein at least a portion of the ground member is plated in a plating material; and
a signal member projecting from the base plate adjacent to the ground member, the signal member comprising a first post disposed at least partially within an opening of the base plate and a second post that connects the signal member to the base plate, wherein at least a portion of the signal member is plated in the plating material and the second post is not plated.

2. The antenna element of claim 1, wherein the first post of the signal member is plated in the plating material and connected to a conductor within the opening of the base plate.

3. The antenna element of claim 1, wherein the ground member comprises a first post and a second post that connect the ground member to the base plate.

4. The antenna element of claim 3, wherein the ground member and the signal member are positioned such that the first post of the ground member and the first post of the signal member are proximate to each other.

5. The antenna element of claim 4, wherein the first post of the ground member is plated in the plating material and the second post of the ground member is not plated.

6. The antenna element of claim 1, wherein the signal member is a first signal member and the antenna element further comprises a second signal member projecting from the base plate adjacent to the first signal member, the second signal member comprising a first post and a second post.

7. The antenna element of claim 6, further comprising a second ground member projecting from the base plate adjacent to the first post of the second signal member.

8. The antenna element of claim 6, wherein the second post of the first signal member and the second post of the second signal member are integrally manufactured together.

9. The antenna element of claim 1, wherein at least a portion of the base plate is plated in the plating material.

10. The antenna element of claim 1, wherein the base plate is electrically grounded.

11. The antenna element of claim 1, wherein the signal member is electrically isolated from the base plate and the ground member.

12. The antenna element of claim 1, wherein the base plate, the ground member, and the signal member are formed using an additive manufacturing process.

13. The antenna element of claim 10, wherein the additive manufacturing process includes stereolithography.

14. The antenna element of claim 10, wherein the additive manufacturing process includes vat polymerization.

15. The antenna element of claim 10, wherein the additive manufacturing process includes 3D printing.

16. The antenna element of claim 1, wherein the plating material comprises copper.

17. The antenna element of claim 1, wherein the base plate, the ground member, and the signal member each comprise at least one plastic.

18. A phased array antenna comprising a plurality of unit cells, wherein each unit cell comprises:
a base plate;
a ground member projecting from the base plate, wherein at least a portion of the ground member is plated in a plating material; and
a signal member projecting from the base plate adjacent to the ground member, the signal member comprising a first post disposed at least partially within an opening of the base plate and a second post that connects the signal member to the base plate, wherein at least a portion of the signal member is plated in the plating material and the second post is not plated.
